(19) United States
(12) Patent Application Publication
(10) Pub. No.: US 2004/0104878 A1
(43) Pub. Date: Jun. 3, 2004

(54) Display device and its gamma correction method

(75) Inventors: Yusuke Tsutsui, Anpachi-gun (JP); Makoto Kitagawa, Anpachi-gun (JP); Mitsugu Kobayashi, Nogoya-shi (JP)

Correspondence Address: MORRISON & FOERSTER LLP, 1650 TYSONS BOULEVARD, SUITE 300, MCLEAN, VA, 22102, US

(73) Assignee: Sanyo Electric Co., Ltd., Moriguchi-City (JP)

(21) Appl. No.: 10/620,807

(22) Filed: Jul. 17, 2003

(30) Foreign Application Priority Data
Jul. 17, 2002 (JP) 2002-207918

(51) Int. Cl. G09G 3/36

(52) U.S. Cl. 345/89

(57) ABSTRACT

RGB display data is sequentially divided and written into pixels of each of the RGB in a display device. The display device has a DA converter selecting and outputting one of plurality of the γ-correction voltages based on the sequentially divided RGB display data, the γ-correction voltage switching circuit selecting the γ-correction voltage for each of the RGB by changing the first and second reference voltages for each of the RGB, and the switching circuit selectively supplying the output of the DA converter to the pixels of each of the RGB. The γ-correction is individually performed for each of the RGB. The individual γ-correction for each of the RGB can improve the reproducibility of colors without enlarging the circuit size.

### BACKGROUND OF THE INVENTION

1. Field of Invention

This invention relates to a display device, such as an liquid crystal display device, and its γ (gamma)-correction method. This invention especially relates to a display device that shows display images through writing RGB display data (display signals of red, green and blue color components) into each of the RGB pixels by dividing them in a time sequence and its γ correction method.

2. Description of Related Art

FIG. 6 is a circuit diagram of a conventional liquid crystal display device. A display region 10 has a plurality of RGB pixels disposed in a matrix configuration with n columns and m rows. Each RGB pixel has a pixel selection transistor, a liquid crystal, and a storage capacitance element.

A gate line 11 extending in the column direction is connected to a gate of the pixel selection transistor, and a drain line 12 extending in the row direction is connected to a drain of the transistor. A vertical scanning signal is consecutively supplied from a shift resister 13 of a vertical scanner to the gate line 11 of each column, and the pixel selection transistor is selected accordingly.

The RGB display data of the first row is stored in a resister 21-1 and inputted to a DA converter 23-1 at the first row based on a horizontal scanning signal from a shift resister 20-1 of a horizontal scanner. A γ-correction voltage of the DA converter 23-1 is supplied from a γ-correction voltage generating circuit 24. The output from the DA converter 23-1 is supplied to the drain line 12 through an amplifier 25-1 and written into the selected RGB pixel of the first row. The same applies to the second, third, - - - rows. Therefore, the explanation is omitted.

FIG. 7 is a circuit diagram of the DA converter 23-1 and the γ-correction voltage generating circuit 24. The DA converter 23-1 is connected between a connection point of each resistance string 30 of the γ-correction voltage generating circuit 24 and an output terminal 32. The DA converter 23-1 includes a group of switching elements 33-1, 33-2, - - - that turn on and off according to the RGB data.

The γ-correction voltage generating circuit 24 can accommodate the line inverting operations of a γ-correction voltage generating circuit 40 for black with positive polarity, a γ-correction voltage generating circuit 41 for black with negative polarity, a γ-correction voltage generating circuit 42 for white with positive polarity, a γ-correction voltage generating circuit 43 for white with negative polarity. The γ-correction voltage generating circuit 24 has switching elements 34, 35 and the resistance string 30 for selecting the output of four circuits described above based on a polarity switching signal PC.

The output of the γ-correction voltage generating circuit 40 for black with positive polarity is supplied to one end of the resistance string 30 as the reference voltage Vref(B) for black display and the output of the γ-correction voltage generating circuit 42 for white with positive polarity is supplied to the other end of the resistance string 30 as the reference voltage Vref(W) for white display when the polarity switching signal PC is HIGH.

The output of the γ-correction voltage generating circuit 41 for black with negative polarity is supplied to one end of the resistance string 30 as the reference voltage Vref(B) for black display and the output of the γ-correction voltage generating circuit 43 for white with negative polarity is supplied to the other end of the resistance string 30 as the reference voltage Vref(W) for white display when the polarity switching signal PC is LOW.

The operation of the display device described above is now explained by referring to an operation timing chart of FIG. 8. Horizontal starting pulses HST are shifted by the shift resisters 20-1, 20-2, 20-3, and the horizontal scanning signals S/R 0-2 is consecutively generated. The RGB display data that is consecutively sent based on the horizontal scanning signal is then stored in the resisters 21-1, 21-2, and 21-3.

The RGB display data outputted from the resisters 21-1,21-2, and 21-3 is then converted into an analog signal by the DA converters 23-1, 23-2 and 23-3 and the γ-correction is simultaneously performed to the analog signal based on the γ-correction voltage from the γ-correction voltage generating circuit 24. The analog signal is then written into each of the selected RGB pixels through the drain line 120.

### SUMMARY OF THE INVENTION

The same γ-correction is performed for each of R, G and B components of the RGB display signals using the same γ-correction voltage in the conventional display device described above. Therefore, the reproducibility of each color is limited. However, adding an individual γ-correction circuit for each color component for better reproducibility requires increasing the size of the circuit.

The RGB display signals are divided in a time sequence for each of the RGB components and written into each of RGB pixels in a display device in this invention. The invention provides a display device displaying a color image made of a plurality of color components. The device includes a plurality of pixels for each of the color components, and a γ-correction voltage switching circuit outputting γ-correction voltages that are generated independently for each of the color components. The pixels are configured to receive display signals at different timings of a time sequence for displaying the color image depending on the color components and the display signals are corrected by the corresponding γ-correction voltages prior to the reception by the pixels.

The invention also provides a display device displaying a color image made of a plurality of color components. The device includes a plurality of pixels for each of the color components and a plurality of DA converters. Each of the DA converters outputting a voltage to a predetermined number of the pixels. The device also includes a γ-correction voltage switching circuit correcting the voltages outputted to the pixels independently for each of the color components, and a switching circuit provided for each set of the predetermined number of the pixels. The switching circuit receives the voltage corrected by the γ-correction voltage switching circuit and outputted by the corresponding DA converter and supplies the voltage selectively to one of the set of the predetermined number of the pixels depending on the color component of said one pixel at a timing of a time sequence different from timings corresponding to other color components.

The invention also provides a γ-correction method of a display device displaying a color image made of a plurality of color components. The method includes receiving display signals corresponding to the color components, performing a γ-correction on the display signals independently for each of the color components, and writing the γ-corrected display signals for each of the color components at a timing of a time sequence for displaying the color image, the timings of the writing being different among the color components.

### BRIEF DESCRIPTION OF THE DRAWINGS

FIG. 1 is a circuit diagram of a liquid crystal display device of a first embodiment of this invention.

FIG. 2 is a circuit diagram of a DA converter and a correction voltage switching circuit. shown in FIG. 1.

FIG. 3 is an operation timing chart of the liquid crystal display device of FIG. 1.

FIG. 4 is a circuit diagram of a liquid crystal display device of a second embodiment of this invention.

FIG. 5 is an operation timing chart of the liquid crystal display device of FIG. 4.

FIG. 6 is a circuit diagram of a conventional liquid crystal display device.

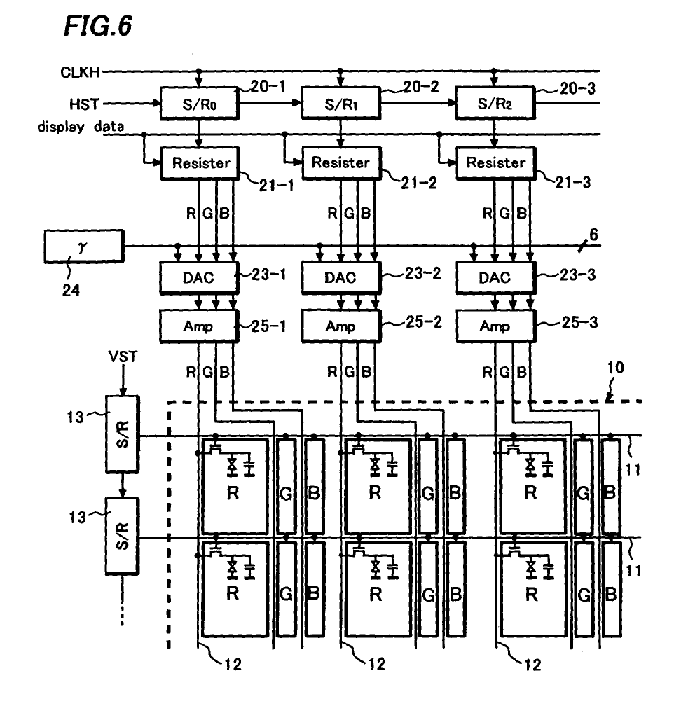

FIG. 7 is a circuit diagram of a DA converter and a γ-correction voltage generating circuit shown in FIG. 6.

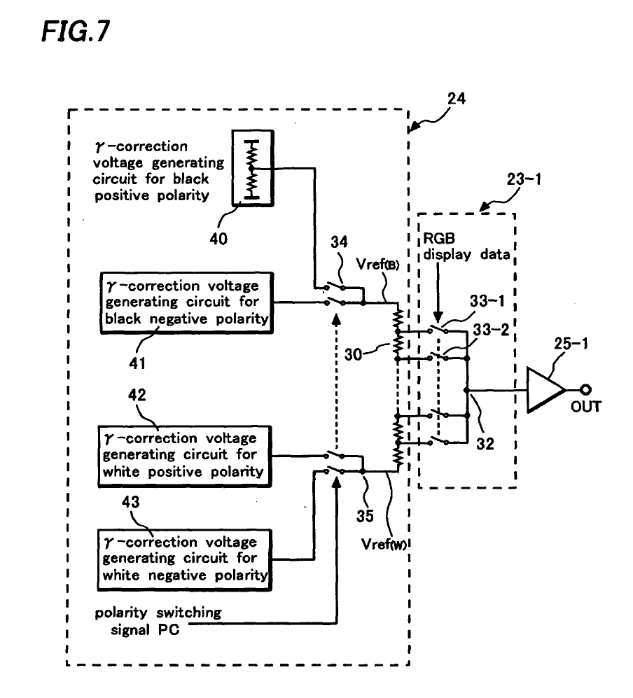

FIG. 8 is an operation timing chart of the conventional liquid crystal display device of FIG. 6.

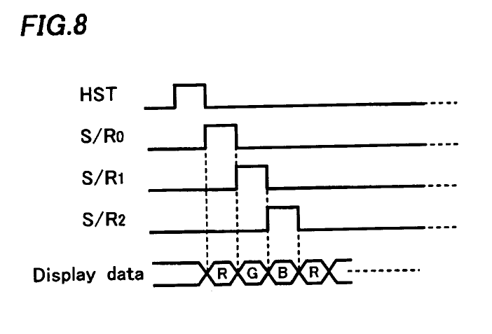

### DETAILED DESCRIPTION OF THE INVENTION

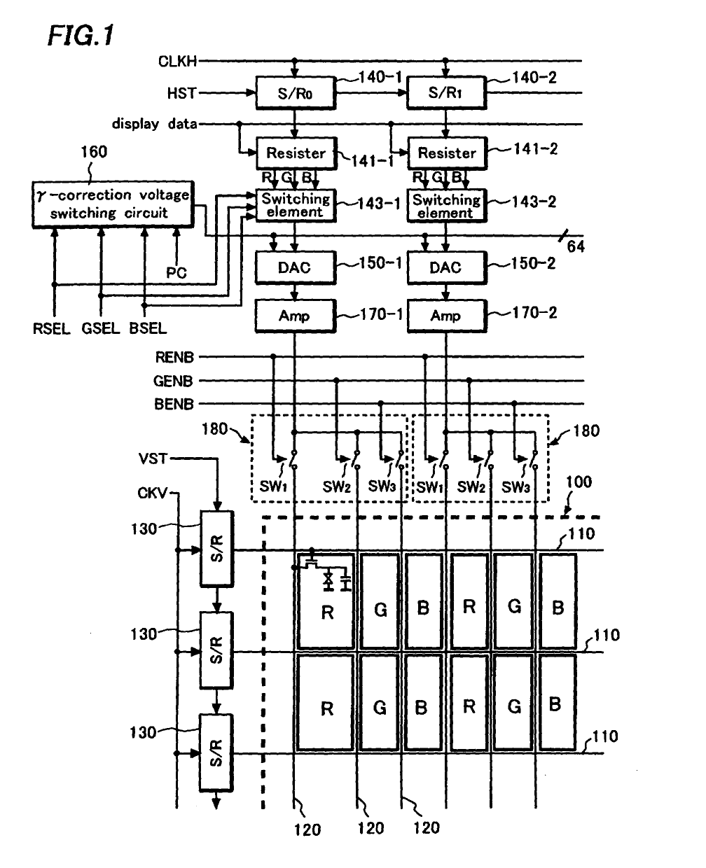

FIG. 1 is a circuit diagram of a liquid crystal display device of a first embodiment of this invention. A display region 100 has a plurality of RGB pixels arranged in a matrix configuration with n columns and m rows. Each RGB pixel has a pixel selection transistor, a liquid crystal, and a storage capacitance element.

A gate line 110 extending in the column direction is connected to a gate of the pixel selection transistor, and a drain line 120 extending in the row direction is connected to a drain of the transistor. A vertical scanning signal is consecutively supplied from a shift resister 130 of a vertical scanner to the gate line 110 of each column, and the pixel selection transistor is selected accordingly.

The RGB display data inputted parallel based on a horizontal scanning signal from a shift resister 140-1 of a horizontal scanner is stored in a resister 141-1 at the first row. The RGB display data inputted parallel based on the horizontal scanning signal from the shift resister 140-2 of the horizontal scanner is stored in the resister 141-2 at the second row. The same sequence applies to other rows.

The RGB display data is taken into each of the resisters 141-1, 141-2 - - - during one horizontal period. If each RGB of the RGB display data has 6 bits, each of the resisters 141-1, 141-2 - - - is also configured to store six-bit display data.

Each of the corresponding RGB display data stored in each of the resisters 141-1, 141-2 - - - is then outputted during R writing period, G writing period, or B writing period of the following one horizontal period.

At the first row, the RGB display data outputted from the resister 141-1 of the first row during the writing period described above is then selected by a switching element 143-1 and inputted to a DA converter 150-1. The DA converter 150-1 is provided with a γ-correction voltage that is generated by a γ-correction voltage switching circuit 160 and outputted for each of the RGB display data based on a R selection signal RSEL, a G selection signal GSEL or a B selection signal BSEL.

The output of the DA converter 150-1, which is the signal with an analog conversion and an individual γ-correction performed for each of the RGB display data, is now applied to a switching circuit 180 through an amplifier 170-1. The switching circuit 180 includes three switching elements, SW1, SW2, and SW3 that turn on and off based on R writing enable signal RENB, G writing enable signal GENB, and B writing enable signal BENB. These three switching elements are configured by, for example, N-channel type TFTs.

The R writing enable signal RENB becomes HIGH during the R writing period, turning the switching element SW1 on and the switching elements SW2 and SW3 off. Therefore, an R analog signal, on which the γ-correction has been individually performed, is written into the selected R pixel.

Likewise, the G writing enable signal GENB becomes HIGH during the G writing period, turning the switching element SW2 on and the switching elements SW1 and SW2 off. And a G analog signal, on which the γ-correction has been individually performed, is written into the selected G pixel. Also, the B writing enable signal BENB becomes HIGH during the B writing period, turning the switching element SW3 on and the switching elements SW1 and SW2 off. Therefore, a B analog signal, on which the γ-correction has been individually performed, is written into the selected B pixel. The same process takes place at other rows.

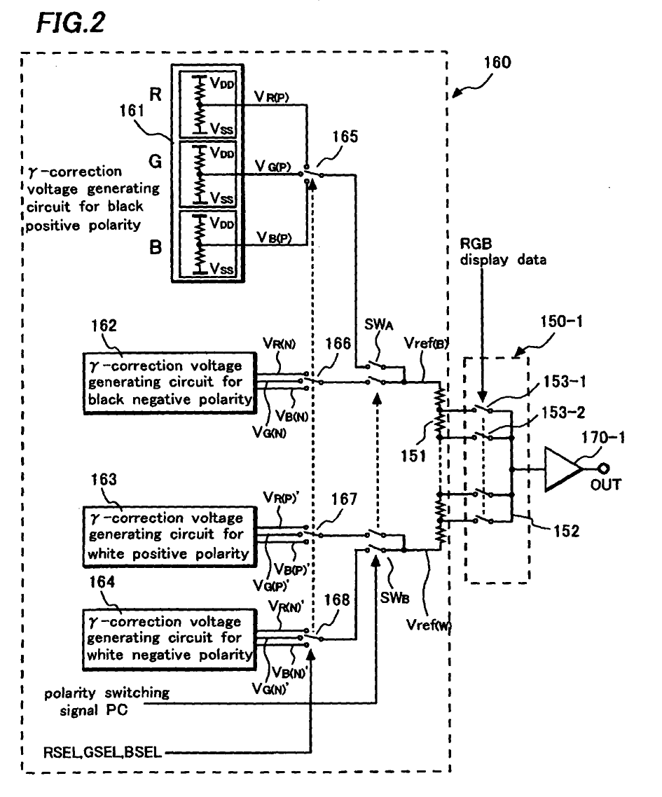

Next, the configuration of the DA converter 150-1 and a correction voltage switching circuit 160 will be explained by referring to FIG. 2. The figure only shows the DA converter 150-1 at the first row, but other DA converters 150-2, - - - at other rows have the same configuration.

The DA converter 150-1 includes a group of switching elements 153-1, 153-2, - - - that turn on and off according to the RGB display data. Each of the switching elements 153-1, 153-2, - - - is connected between a connection point of each resistance string 151 of the correction voltage switching circuit 160 and an output terminal 152.

The γ-correction voltage switching circuit 160 has a γ-correction voltage generating circuit 161 for black with positive polarity, a γ-correction voltage generating circuit 162 for black with negative polarity, a γ-correction voltage generating circuit 163 for white with positive polarity, a γ-correction voltage generating circuit 164 for white with negative polarity, and the resistance string 151.

The γ-correction voltage generating circuit 161 for black with positive polarity generates the γ-correction voltage for R VR(P), the γ-correction voltage for G VG(P), and the γ-correction voltage for B VB(P), which are different from each other by using a voltage divider circuit. One of the γ-correction voltage for R VR(P), the γ-correction voltage for G VG(P), or the γ-correction voltage for B VB(P) is selected according to the R selection signal RSEL, the G selection signal GSEL or the B selection signal BSEL. For example, the γ-correction voltage for R VR(P) will be selected and outputted when the R selection signal RSEL is HIGH and the other two signals, the G selection signal GSEL and the B selection signal BSEL are LOW.

The γ-correction voltage generating circuit 162 for black with negative polarity, the γ-correction voltage generating circuit 163 for white with positive polarity, and the γ-correction voltage generating circuit 164 for white with negative polarity are configured in the same manner in order to select and output different γ-correction voltage according to the R selection signal RSEL, the G selection signal GSEL or the B selection signal BSEL.

Additionally, switching elements SWA and SWB for selecting the outputs of these four circuits based on a polarity switching signal PC are formed, which enable the line inverting operation of the liquid crystal. The output from the γ-correction voltage generating circuit 161 for black with positive polarity is supplied to one end of the resistance string 151 through a switching element 165 and the switching element SWA as the black reference voltage Vref(B), and the output from the γ-correction voltage generating circuit 163 for white with positive polarity is supplied to the other end of the resistance string 151 through a switching element 167 and the switching element SWB as the white reference voltage Vref(W) when the polarity switching signal PC is HIGH.

The output from the γ-correction voltage generating circuit 162 for black with negative polarity is supplied to one end of the resistance string 151 through a switching element 166 and the switching element SWA as the black reference voltage Vref(B), and the output from the γ-correction voltage generating circuit 164 for white with negative polarity is supplied to the other end of the resistance string 151 through a switching element 168 and the switching element SWB as the white reference voltage Vref(W) when the polarity switching signal PC is LOW.

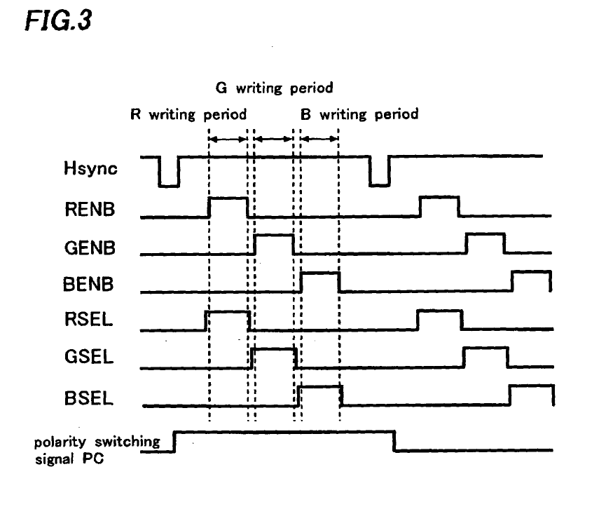

The operation of the configuration of the display device described above will be explained by referring to a timing chart shown in FIG. 3. Suppose each of the resisters 141-1, 141-2, - - - has already acquired the RGB display data desirable for each resister before one horizontal period.

Also, suppose the polarity switching signal PC stays HIGH (positive polarity) during this one horizontal period. Since the R display data is written into the R pixel while the R wiring enable signal RENB is HIGH, this period is called the R writing period.

The γ-correction voltage for R positive polarity VR(P) is selected by the switching element 165 and supplied as the reference voltage for black Vref(B) through the switching element SWA to one end of the resistance string 151 when the R selection signal RSEL becomes HIGH during the R writing period. Simultaneously, the γ-correction voltage for R positive polarity VR(P)′ is selected by the switching element 167 and supplied as the reference voltage for white Vref(W) through the switching element SWB to the other end of the resistance string 151. The γ-correction voltage generated by the resistance string 151 is supplied to the DA converters 150-1, 150-2, - - - .

Then, the DA conversion for the R display data is performed based on the γ-correction voltage described above. The R analog signal is written into the R pixel at the selected row through the amplifiers 170-1, 170-2, the switching element SW1 and the drain line 120.

Next, the G writing enable signal GENB becomes HIGH after the R writing enable signal RENB changes to LOW. It is the start of the G writing period, and therefore all the G display data is outputted from the resisters 141-1, 142-2, - - - . Also, only the switching element SW2 of the switching circuit 180 turns on.

The γ-correction voltage for G positive polarity VG(P) is selected by the switching element 165 and supplied as the reference voltage for black Vref(B) through the switching element SWA to one end of the resistance string 151 when the G selection signal GSEL becomes HIGH during the G writing period. Simultaneously, the γ-correction voltage for G positive polarity VG(P)′ is selected by the switching element 167 and supplied as the reference voltage for white Vref(W) through the switching element SWB to the other end of the resistance string 151. The γ-correction voltage generated by the resistance string 151 is supplied to the DA converters 150-1, 150-2, - - - .

Then, the DA conversion for the G display data is performed based on the γ-correction voltage described above. The G analog signal is written into the G pixel at the selected row through the amplifiers 170-1, 170-2, the switching element SW2 and the drain line 120.

Next, the B writing enable signal BENB becomes HIGH after the G writing enable signal GENB changes to LOW. It is the start of the B writing period, and therefore all the B display data is outputted from the resisters 141-1, 142-2, - - - . Also, only the switching element SW3 of the switching circuit 180 turns on.

The γ-correction voltage for B positive polarity VB(P) is selected by the switching element 165 and supplied as the reference voltage for black Vref(B) through the switching element SWA to one end of the resistance string 151 when the B selection signal BSEL becomes HIGH during the B writing period. Simultaneously, the γ-correction voltage for B positive polarity VB(P)′ is selected by the switching element 167 and supplied as the reference voltage for white Vref(W) through the switching element SWB to the other end of the resistance string 151. The γ-correction voltage generated by the resistance string 151 is supplied to the DA converters 150-1, 150-2, - - - .

Then, the DA conversion for the B display data is performed based on the γ-correction voltage described above. The B analog signal is written into the B pixel at the selected row through the amplifiers 170-1, 170-2, the switching element SW3 and the drain line 120.

The same operation will be repeated during the next one horizontal period except that the polarity switching signal PC changes to LOW and the γ-correction voltage for negative polarity is outputted from the γ-correction voltage switching circuit 160.

It is preferable that the R selection signal RSEL becomes HIGH before the R writing enable signal RENB becomes HIGH in order to perform an accurate γ-correction by executing the writing operation into the R pixel after the right γ-correction voltage is selected. For the same reason, it is preferable that the R selection signal RSEL becomes LOW after the R writing enable signal RENB becomes LOW.

The same time sequence applies to the relations between the G selection signal GSEL and the G writing enable signal GENB as well as between the B selection signal BSEL and the B writing enable signal BENB.

The γ-correction voltage switching circuit 160 selects the γ-correction voltage for each of the components of the RGB color signals in order to perform the γ-correction individually for the individual color components in this embodiment. Therefore, the reproducibility of the color of the liquid crystal display device can be improved by setting the γ-correction voltage at the optimum level individually for each of the RGB components. Also, the writing period is divided corresponding to the each of the RGB color components in this embodiment, therefore, it is not necessary to form the γ-correction circuit for each of the RGB color components, preventing the enlargement of the circuit scale.

In a second embodiment of this invention, the number of the time-division of the RGB display data writing period is doubled, making the circuit scale even smaller. The γ-correction voltage is selected for each of the writing period as it is done in the first embodiment.

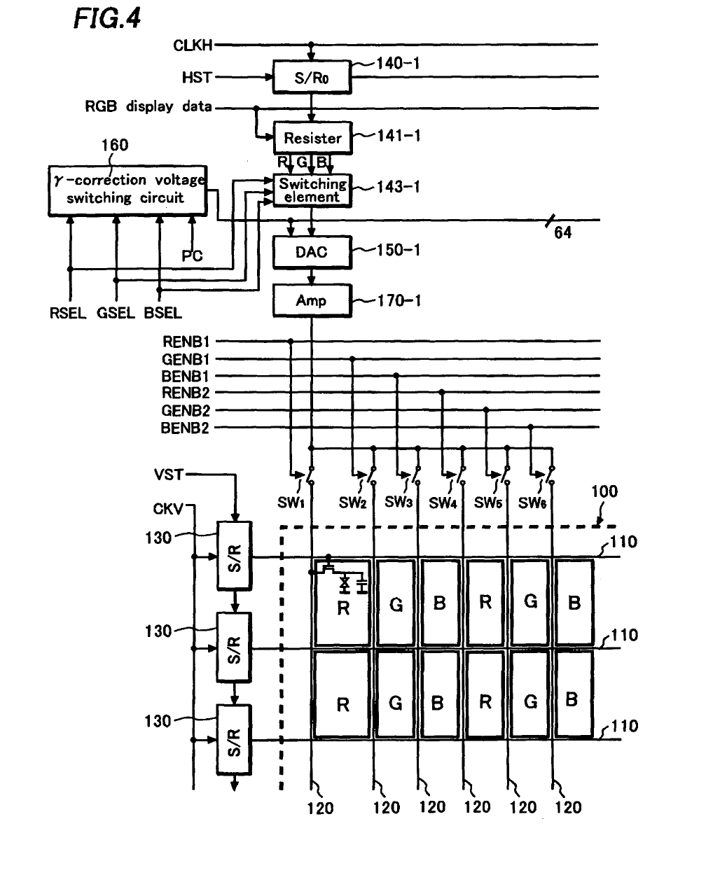

FIG. 4 is a circuit diagram of the liquid crystal display device of this embodiment. The circuit of this embodiment differs from the first one only at the following point: as the number of the time-division of the RGB display data writing period increases, the number of the writing enable signals and the number of the switching elements that turn on and off based on the writing enable signal are also increased. However, since one DA converter is required for every six rows of the pixels, the circuit size of the peripheral circuit of the pixel is reduced.

The writing enable signals include the following six signals; a first R writing signal RENB1, a first G writing signal GENB1, a first B writing signal BENB1, a second R writing signal RENB2, a second G writing signal GENB2, and a second B writing signal BENB2. Also, the switching elements controlled by the six writing enable signals described above include six switching elements SW1-SW6.

The shift resister S/R0, the resister 141-1, a switching element 143-1, the DA converter 150-1, and the amplifier 170-1 for one row are shown in FIG. 4. But the same configuration applied to other rows.

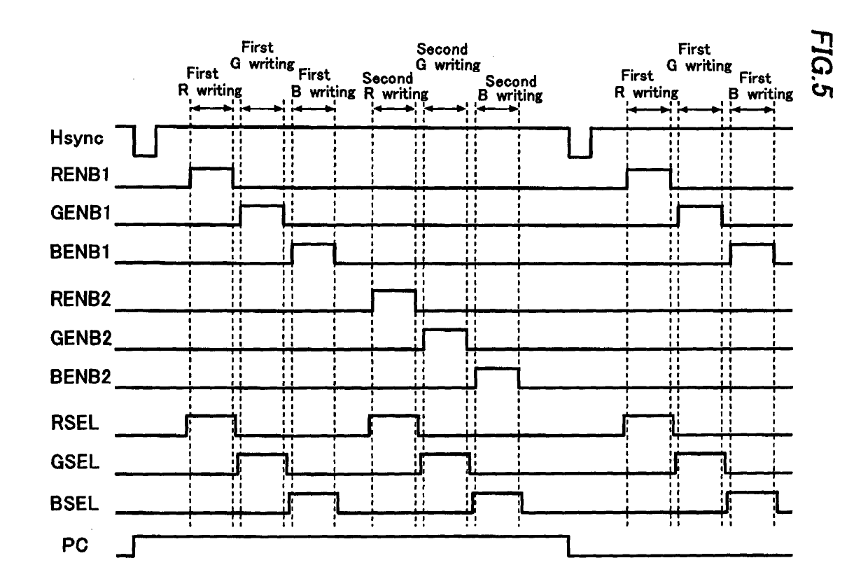

Next, the operation of the liquid crystal display device of this embodiment will be explained by referring to FIG. 5. Although the following explanation is based on the operation of the first row in FIG. 4 as an example, the same applies to other rows. Suppose the resister 141-1 has already acquired the desirable RGB display data corresponding to the six pixels before one horizontal period.

The first R writing signal RNEB 1, the first G writing signal GNEB1, the first B writing signal BNEB1, the second R writing signal RNEB2, the second G writing signal GNEB2, and the second B writing signal BNEB2 consecutively become HIGH during one horizontal period.

The R selection signal RSEL becomes HIGH during two R writing periods, the G selection signal GSEL becomes HIGH during two G writing periods, and the B selection signal BSEL becomes HIGH during two B writing periods, as shown in FIG. 5. Accordingly, display data corresponding to each of the six pixels is written into the respective pixel.

Therefore, an accurate γ-correction is performed individually for each of the RGB because a different γ-correction voltage is selected for each of the RGB during each of the writing periods, as in the first embodiment. Although each of the RGB display data writing periods is divided into two in this embodiment, it is also possible to divide the writing period into three or more periods.

The RGB display data writing period is divided during one horizontal period in both the first and the second embodiments. However, this invention is not limited to this configuration. It is also applicable to a liquid crystal display device of field sequential. In this case, the RGB data writing period is divided during one vertical period. The RGB display data is stored in the field memory in the liquid crystal display device of field sequential, and the R, G, and B data are divided and sequentially written during one vertical period. In this device, the selecting of the γ-correction voltage is required only three times during the one vertical period, decreasing the number of required switching times.

Although the invention is described using the liquid crystal display device as a platform in both the first and the second embodiments, this invention is not limited to such a platform. It is also applicable to an electroluminescent display device and especially a organic electroluminescent display device.

What is claimed is:

1. A display device displaying a color image made of a plurality of color components, comprising:
a plurality of pixels for each of the color components; and
a γ-correction voltage switching circuit outputting γ-correction voltages that are generated independently for each of the color components,
wherein the pixels are configured to receive display signals at different timings of a time sequence for displaying the color image depending on the color components and the display signals are corrected by the corresponding γ-correction voltages prior to the reception by the pixels.

2. A display device displaying a color image made of a plurality of color components, comprising:
a plurality of pixels for each of the color components;
a plurality of DA converters, each of the DA converters outputting a voltage to a predetermined number of the pixels;
a γ-correction voltage switching circuit correcting the voltages outputted to the pixels independently for each of the color components; and
a switching circuit provided for each set of the predetermined number of the pixels, the switching circuit receiving the voltage corrected by the γ-correction voltage switching circuit and outputted by the corresponding DA converter and supplying the voltage selectively to one of the set of the predetermined number of the pixels depending on the color component of said one pixel at a timing of a time sequence different from timings corresponding to other color components.

3. The display device of claim 2, wherein the DA converter outputting the voltage as a voltage divided by a resistance string between a first reference voltage and a second reference voltage and the γ-correction voltage switching circuit modifies the first and second reference voltages.

4. The display device of claim 2, further comprising a resister provided for each set of the predetermined number of the pixels, the resister storing display signals corresponding to the color components and outputting the display signals in a time sequence corresponding to the time sequence of the switching circuit.

5. The display device of claim 3, wherein the γ-correction voltage switching circuit comprises a black reference voltage generating circuit outputting three different black reference voltages and a switching element outputting one of the three black reference voltages in response to a selection signal, and the first reference voltage comprises the output voltage of the switching element.

6. The display device of claim 3, wherein the γ-correction voltage switching circuit comprises a white reference voltage generating circuit outputting three different white reference voltages and a switching element outputting one of the three white reference voltages in response to a selection signal, and the second reference voltage comprises the output voltage of the switching element.

7. A γ-correction method of a display device displaying a color image made of a plurality of color components, comprising:
receiving display signals corresponding to the color components;
performing a γ-correction on the display signals independently for each of the color components; and
writing the γ-corrected display signals for each of the color components at a timing of a time sequence for displaying the color image, the timings of the writing being different among the color components.
